(19) United States
(12) Patent Application Publication
(10) Pub. No.: US 2020/0402707 A1
(43) Pub. Date: Dec. 24, 2020

(54) MAGNETIC ELEMENT

(71) Applicant: NTN Corporation, Osaka (JP)

(72) Inventors: Kayo SAKAI, Aichi (JP); Eiichirou SHIMAZU, Aichi (JP)

(21) Appl. No.: 16/977,598

(22) PCT Filed: Feb. 28, 2019
(86) PCT No.: PCT/JP2019/007821

§ 371 Date: Sep. 2, 2020

(30) Foreign Application Priority Data
Mar. 26, 2018 (JP) 2018-058196

(51) Int. Cl. H01F 27/29; H01F 17/04; H01F 27/255

(52) U.S. Cl. CPC H01F 27/292; H01F 2017/048; H01F 27/255; H01F 17/04

(57) ABSTRACT

Provided is a magnetic element, including: a coil assembly in which a coil is provided on an outer periphery of an inner core; and an outer peripheral core provided to cover an outer periphery of the coil assembly. The outer peripheral core has: an opening that allows the coil assembly to be inserted therein; and a fixing part configured to fix the coil assembly into the outer peripheral core. The coil is sealed by a sealing resin. A lid member is mounted to an opening of the outer peripheral core, and is configured to reduce a gap between the coil and the outer peripheral core in the opening so as to reduce a filling amount of the sealing resin.

### TECHNICAL FIELD

The present invention relates to a magnetic element in which a coil assembly is provided around a magnetic member, and which is used as an inductor, a transformer, an antenna (bar antenna), a choke coil, a filter, a sensor, or other component in electric apparatus or electronic apparatus. In particular, the present invention relates to a magnetic element mountable on a substrate.

### BACKGROUND ART

In recent years, electric apparatus or electronic apparatus have advanced toward size reduction, high frequency, and large current. Along with this situation, the same requirements have been imposed on magnetic elements as well. At present, ferrite materials mainly used for magnetic members have reached the limit of material characteristic itself. Then, new materials for the magnetic members have been searched for. For example, the ferrite materials are being replaced by a compression-molded magnetic material such as Sendust and an amorphous material, an amorphous metal foil strip, and other material. However, the above-mentioned compression-molded magnetic materials have poor moldability, and also show low mechanical strength after firing. Further, the above-mentioned amorphous metal foil strip requires high manufacturing cost due to winding, cutting, and gap formation. Thus, it takes a longer time to put those magnetic materials into practical use.

To address this problem, there has been proposed a magnetic element which “requires a small number of operation steps and a small number of components, and enables reduction in usage of copper wire or other metal having high conductivity” (Patent Literature 1). Specifically, as illustrated in FIG. 21 and FIG. 22, the magnetic element includes: a coil assembly 104 in which a coil 103 is provided on an outer periphery of an inner core 102; and an outer peripheral core 105 provided to cover an outer periphery of the coil assembly 104. In this case, the outer peripheral core 105 has an opening 105a that allows the coil assembly 104 to be inserted therein, and grooves 105b as fixing parts for fixing the coil assembly 104 into the outer peripheral core 105.

### CITATION LIST

Patent Literature 1: JP 2017-59811 A

### SUMMARY OF INVENTION

### Technical Problem

In the magnetic element illustrated in FIG. 21 and FIG. 22, the opening 105a of the outer peripheral core 105 has relatively large space between the outer peripheral core 105 and an outer diameter of the coil. Thus, in a case of injecting a sealing resin, a large amount of resin is required. This leads to increases in cost and filling time. Consequently, productivity is lowered.

In view of the above, the present invention provides a magnetic element with which it is possible to reduce a filling amount of a sealing resin, and achieve higher productivity and lower cost.

### Solution to Problem

According to one embodiment of the present invention, there is provided a magnetic element, comprising: a coil assembly in which a coil is provided on an outer periphery of an inner core; an outer peripheral core provided to cover an outer periphery of the coil assembly, the outer peripheral core having: an opening that allows the coil assembly to be inserted therein; and a fixing part configured to fix the coil assembly into the outer peripheral core, the coil being sealed by a sealing resin, wherein a lid member is mounted to an opening of the outer peripheral core, the lid member being configured to reduce a gap between the coil and the outer peripheral core in the opening so as to reduce a filling amount of the sealing resin.

According to the magnetic element of the present invention, the lid member is mounted to the opening of the outer peripheral core, with which it is possible to reduce the gap between the coil and the outer peripheral core in the opening, to thereby reduce the filling amount of the sealing resin.

It is preferred that the lid member have an air hole through which an inside and an outside of the outer peripheral core communicate with each other. Through the formation of the air hole as described above, it is possible to suppress formation of voids in the outer peripheral core, and provide a high-quality magnetic element.

It is preferred that the lid member comprise a guide portion through which a coil terminal is guided to an outside. Through the provision of the guide portion as described above, the coil terminal protruding from the outer peripheral core is connected stably to a connection portion of a substrate.

It is preferred that the lid member comprise a coil positioning portion configured to guide the coil to position the coil and the inner core. In the structure comprising the coil positioning portion, the coil assembly comprising the coil and the inner core can be fixed stably in a normal position by mounting the lid member to the opening of the outer peripheral core, and hence assembly can be easily performed.

It is preferred that an engagement part be provided between the lid member and the outer peripheral core, the engagement part being configured to position the lid member into a state of being mounted to the outer peripheral core. Through the provision of the engagement part, when fitted into the opening of the outer peripheral core, the lid member is mounted to the outer peripheral core while being positioned. Accordingly, no positional alignment is required for the lid member, and an assembly operation can be simplified.

It is preferred that the engagement part comprise a convex and concave fitting structure provided at at least two positions. Through the above-mentioned setting, it is possible to form the engagement part with a simple structure, and also achieve stable engagement state (fitting state).

### Advantageous Effects of Invention

It is possible to reduce the filling amount of the sealing resin, and achieve higher productivity and lower cost.

### BRIEF DESCRIPTION OF DRAWINGS

FIG. 1 is a perspective sectional view for illustrating a first magnetic element of the present invention.

FIG. 2 is a perspective view of the magnetic element of FIG. 1.

FIG. 3 is a sectional plan view for illustrating the magnetic element of FIG. 1.

FIG. 4A is a sectional view for illustrating the magnetic element of FIG. 1, in which a lid member having an inner surface being a recessed curved surface is mounted.

FIG. 4B is a sectional view for illustrating the magnetic element of FIG. 1, in which the lid member having a polygonal inner surface is mounted.

FIG. 5A is a sectional view for illustrating an engagement part being a convex and concave fitting portion with a convex portion having a flattened semi-elliptic shape in cross section, and a concave portion having a flattened semi-elliptic shape in cross section, to which the convex portion is fitted.

FIG. 5B is a sectional view for illustrating the engagement part being the convex and concave fitting portion with the convex portion having a right triangle shape in cross section, and the concave portion having a right triangle shape in cross section, to which the convex portion is fitted.

FIG. 5C is a sectional view for illustrating the engagement part being the convex and concave fitting portion with the convex portion having a right triangle shape in cross section, and the concave portion having a triangle shape in cross section, to which the convex portion is fitted.

FIG. 6A is a perspective view for illustrating the magnetic element under a state in which the lid member is omitted.

FIG. 6B is a front view for illustrating the magnetic element under a state in which the lid member is omitted.

FIG. 7A is a perspective view for illustrating a state before a cylindrical inner core is inserted to a coil.

FIG. 7B is a perspective view for illustrating a state after the inner core is inserted to the coil, and before the coil is fitted into an outer peripheral core.

FIG. 7C is a perspective view for illustrating a state in which the coil having inserted therein the inner core is fitted into the outer peripheral core.

FIG. 8A is a perspective view for illustrating a modification example of the magnetic element of FIG. 1, in which a back wall of the outer peripheral core is formed as a flat wall.

FIG. 8B is a perspective view for illustrating a modification example of the magnetic element of FIG. 1, in which the back wall of the outer peripheral core is formed as a polygonal wall in cross section.

FIG. 9 is a perspective view for illustrating a second magnetic element under a state in which the lid member is omitted.

FIG. 10A is a perspective view for illustrating a state before cylindrical inner cores are inserted to a coil.

FIG. 10B is a perspective view for illustrating a state after the inner cores are inserted to the coil and before the coil is fitted into an outer peripheral core.

FIG. 10C is a perspective view for illustrating a state in which the coil having inserted therein the inner cores is fitted into the outer peripheral core.

FIG. 11 is a perspective view for illustrating a third magnetic element under a state in which the lid member is omitted.

FIG. 12A is a perspective view for illustrating a state before a coil and an inner core are fitted into an outer peripheral core.

FIG. 12B is a perspective view for illustrating a state in which the coil is fitted into the outer peripheral core.

FIG. 12C is a perspective view for illustrating a state in which the coil and the inner core are fitted into the outer peripheral core.

FIG. 13A is a perspective view for illustrating a fourth magnetic element under a state in which the lid member is omitted.

FIG. 13B is a sectional view for illustrating the fourth magnetic element under a state in which the lid member is omitted.

FIG. 13C is a sectional view for illustrating the fourth magnetic element under a state in which the lid member is omitted, in which a fitting portion is provided at another position.

FIG. 14A is a perspective view for illustrating a state before an inner core is fitted into a coil.

FIG. 14B is a perspective view for illustrating a state in which the inner core is fitted into the coil.

FIG. 14C is a perspective view for illustrating a state in which the coil having fitted therein the inner core is fitted into an outer peripheral core.

FIG. 15A is a perspective view for illustrating a fifth magnetic element under a state in which the lid member is omitted.

FIG. 15B is a sectional view for illustrating the fifth magnetic element under a state in which the lid member is omitted.

FIG. 16A is a perspective view for illustrating a state before spacers are fitted to an inner core.

FIG. 16B is a perspective view for illustrating a state in which the spacers are fitted to the inner core.

FIG. 16C is a perspective view for illustrating a state in which the inner core is fitted to a coil.

FIG. 16D is a perspective view for illustrating a state before the coil having fitted thereto the inner core is fitted into an outer peripheral core.

FIG. 17A is a perspective view for illustrating a sixth magnetic element under a state in which the lid member is omitted.

FIG. 17B is a sectional view for illustrating the sixth magnetic element under a state in which the lid member is omitted.

FIG. 18A is a perspective view for illustrating a state before spacers are mounted to an inner core.

FIG. 18B is a perspective view for illustrating a state in which a coil is fitted into an outer peripheral core.

FIG. 18C is an assembly view for illustrating a state in which the coil and the inner core having mounted thereto the spacers are fitted into the outer peripheral core.

FIG. 19A is a perspective view for illustrating a seventh magnetic element under a state in which the lid member is omitted.

FIG. 19B is a sectional view for illustrating the seventh magnetic element under a state in which the lid member is omitted.

FIG. 20A is a perspective view for illustrating a state before spacers are mounted to an inner core.

FIG. 20B is a perspective view for illustrating a state in which the spacers are mounted to the inner core.

FIG. 20C is a perspective view for illustrating a state in which a coil is accommodated in an outer peripheral core.

FIG. 20D is a perspective view for illustrating a state in which after the coil is accommodated in the outer peripheral core, the inner core having mounted thereto the spacers is fitted into the outer peripheral core.

FIG. 21 is a perspective view for illustrated a related-art magnetic element.

FIG. 22 is a view for illustrating an assembly step for the related-art magnetic element.

### DESCRIPTION OF EMBODIMENTS

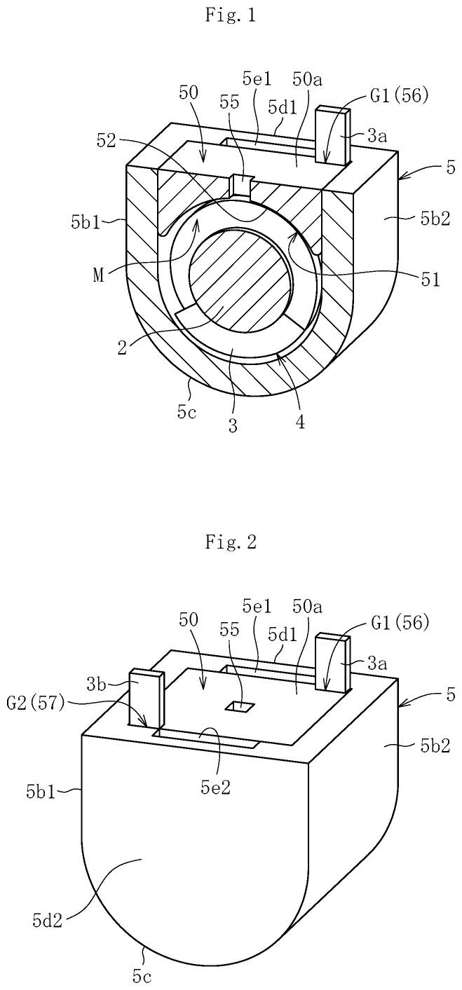

With reference to FIG. 1 to FIG. 20, an embodiment of the present invention is described below.

FIG. 1 to FIG. 4A and FIG. 4B are views for illustrating a first magnetic element (EEP type magnetic element) according to the present invention. The magnetic element comprises: a coil assembly 4 in which a coil 3 is provided on an outer periphery of a cylindrical inner core 2; an outer peripheral core 5 provided to cover an outer periphery of the coil assembly 4; and a lid member 50 to be mounted to an opening of the outer peripheral core 5. The cylindrical inner core 2 is inserted perpendicularly to an axis of the magnetic element, and the inner core 2 and the outer peripheral core 5 are magnetically integrated with each other.

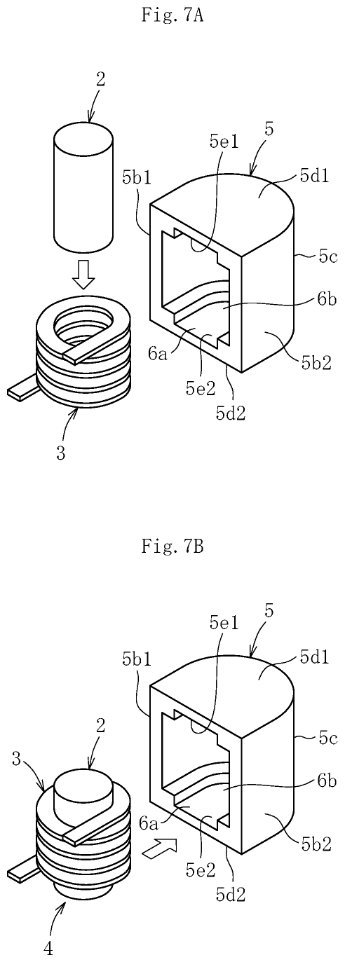

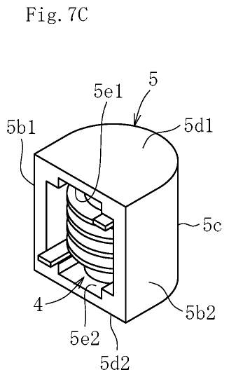

The outer peripheral core 5 has one pair of side walls 5b1 and 5b2, a back wall 5c, and an upper wall 5d1 and a lower wall 5d2, and the back wall 5c has an arc shape. The upper wall 5d1 and the lower wall 5d2 respectively have grooves 5e1 and 5e2 that open at an opening end. As illustrated in FIG. 7, the grooves 5e1 and 5e2 each comprise a linear portion 6a on an opening side and a semicircular portion 6b on a back side thereof.

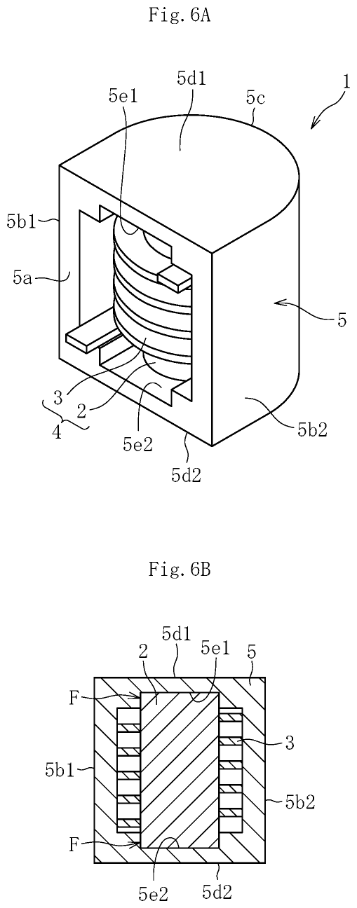

The coil assembly 4 and the outer peripheral core 5 covering the outer periphery of the coil assembly 4 are assembled by a method illustrated in FIG. 7. As illustrated in FIG. 7A, the cylindrical inner core 2 is inserted to the previously wound coil 3 in a direction as indicated by the arrow. Next, as illustrated in FIG. 7B, along the upper groove 5e1 and the lower groove 5e2 each formed in an inner peripheral surface of the outer peripheral core 5, both end portions of the cylindrical inner core 2 are inserted in a direction as indicated by the arrow. Those grooves 5e1 and 5e2 are also used for positional alignment in an axial direction and a radial direction of the cylindrical inner core 2 except the insertion direction thereof. Thus, as illustrated in FIG. 7C, when the coil assembly 4 is inserted to the end along the grooves 5e1 and 5e2, then the both end portions of the inner core 2 are fitted to the semicircular portions 6b on the back side of the grooves 5e1 and 5e2. In this way, the coil assembly 4 is fixed into the outer peripheral core 5. That is, the grooves 5e1 and 5e2, and the both end portions of the inner core 2 form fixing parts F (see FIG. 6B) configured to fix the coil assembly 4 into the outer peripheral core 5.

Since the cylindrical inner core 2 is inserted from a direction perpendicular to the axial direction of the coil, it is not required to perform positional alignment in the axial direction and the radial direction except the insertion direction. With this, assembly is simplified. Further, the outer peripheral core 5 and the cylindrical inner core 2 are to be combined, and hence the number of components can be reduced. The inner core 2 is only required to have a columnar shape, and thus can have a polygonal columnar shape other than the cylindrical shape.

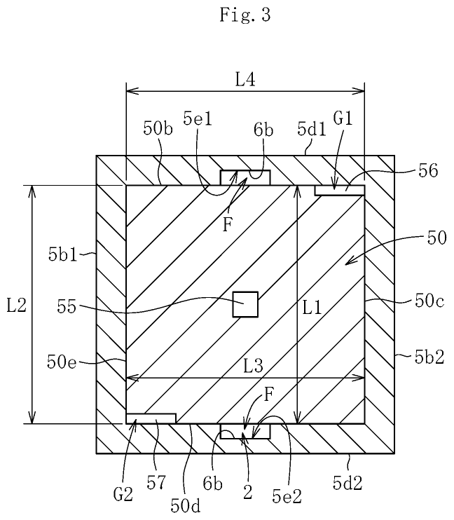

As illustrated in FIG. 1 to FIG. 4A and FIG. 4B, the lid member 50 is formed from a block member having a concave portion 51 formed on an inner side of the outer peripheral core 5, and has an outer shape fittable into the opening of the outer peripheral core 5. Specifically, the lid member 50 has an outer edge surface 50a of a rectangular shape corresponding to an outer shape of the opening of the outer peripheral core 5. In this case, as illustrated in FIG. 3, a dimension L1 of the lid member 50 in the axial direction of the inner core is set to a dimension equal to or slightly smaller than a dimension L2 of the opening of the outer peripheral core 5 in the axial direction of the inner core, and a dimension L3 of the lid member 50 in a direction orthogonal to the axis of the inner core is set to a dimension equal to or slightly smaller than a dimension L4 of the opening of the outer peripheral core 5 in the direction orthogonal to the axis of the inner core. Here, the term “dimension slightly smaller” refers to such a dimension that the lid member 50 is fittable into the opening of the outer peripheral core 5, and no backlash occurs after the fitting. The outer edge surface 50a of the lid member 50 may have a rectangular shape or a square shape.

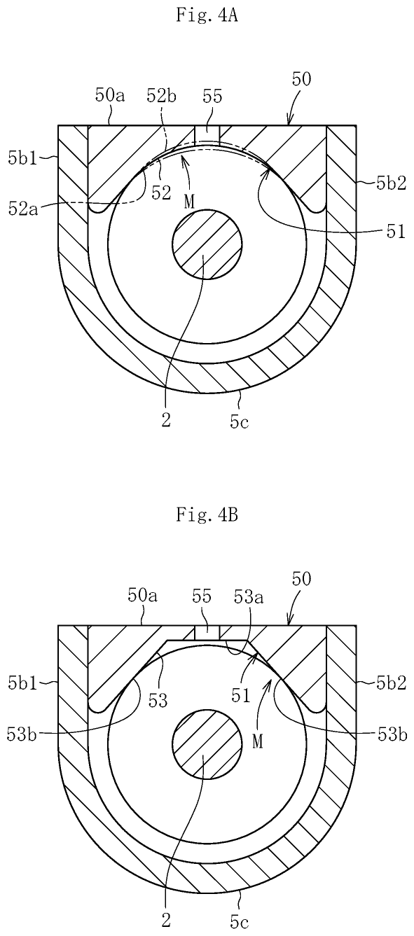

As illustrated in FIG. 1 and FIG. 4A, an inner surface 52 of the concave portion 51 of the lid member 50 is a recessed curved surface with a radius of curvature corresponding to a radius of curvature of an outer diameter surface of the coil 3 that is installed while being wound into a spiral shape. Thus, under a state in which the lid member 50 is fitted to the opening 5a of the outer peripheral core 5, the inner surface 52a of the concave portion 51 of the lid member 50 is brought into contact with the outer diameter surface of the coil 3. That is, the concave portion 51 of the lid member 50 forms a coil positioning portion M configured to guide the coil, and position the coil 3 and the inner core 2. The radius of curvature of the recessed curved surface of the inner surface 52 of the concave portion 51 of the lid member 50 is not limited to the same one as the radius of curvature of the outer diameter surface of the coil 3 as indicated by the solid line of FIG. 4A, but may be larger than the radius of curvature of the outer diameter surface of the coil 3 as indicated by a virtual line 52a, or may be smaller than the radius of curvature of the outer diameter surface of the coil 3 as indicated by a virtual line 52b.

Here, as illustrated in FIG. 4B, the concave portion 51 of the lid member 50 can be formed to have a polygonal (trapezoidal) inner surface 53. Specifically, in this case, the inner surface 53 of the concave portion 51 is defined by a parallel surface 53a that is parallel to the outer edge surface 50a of the lid member 50, and tapered surfaces 53b and 53b that spread open toward the inner side from both end portions of the parallel surface 53a. Thus, under a state in which the lid member 50 is fitted to the opening 5a of the outer peripheral core 5, the tapered surfaces 53b and 53b of the inner surface 53 are brought into contact with the outer diameter surface of the coil 3. That is, the concave portion 51 of the lid member 50 forms the coil positioning portion M configured to guide the coil 3, and position the coil 3 and the inner core 2.

Further, the lid member 50 has an air hole 55 through which the inside and the outside of the outer peripheral core 5 communicate with each other. The air hole 55 is a rectangular hole open at a center portion of the outer edge surface 50a of the lid member 50. Further, the lid member 50 has a cutout 56 on one side wall side being the side wall 5b2 side, at the upper wall 5d1 side of the outer peripheral core 5. The cutout 56 forms a guide portion G1 along which a coil terminal 3a as one coil terminal of the coil 3 is led out to the outside. Further, a cutout 57 is formed on another side wall side being the side wall 5b1 side, at the lower wall 5d2 side of the outer peripheral core 5. The cutout 57 forms a guide portion G2 along which a coil terminal 3b as another coil terminal of the coil 3 is led out to the outside. It is preferred that the guide portions G1 and G2 have such a size that the coil terminals 3a and 3b can be guided (inserted) and also cause no backlash.

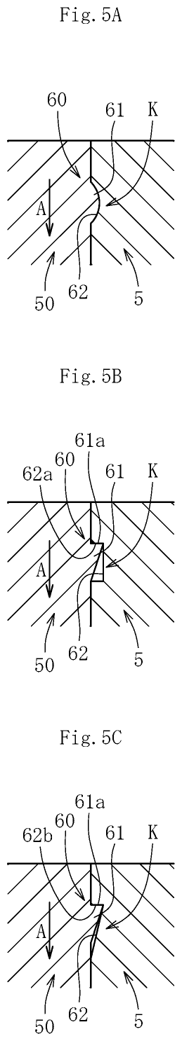

Further, as illustrated in FIG. 5A, FIG. 5B, and FIG. 5C, an engagement part K is provided between the lid member 50 and the outer peripheral core 5. The engagement part K is configured to position the lid member 50 into a state of being mounted to the outer peripheral core 5. The engagement part K is formed from a convex and concave fitting structure 60. In FIG. 5A, a convex portion 61 has a flattened semi-elliptic shape in cross section, and a concave portion 62 has a flattened semi-elliptic shape in cross section, to which the convex portion 61 is fitted. In FIG. 5B, the convex portion 61 has a right triangle shape in cross section, and the concave portion 62 has a rectangular shape in cross section, to which the convex portion 61 is fitted. In FIG. 5C, the convex portion 61 has a right triangle shape in cross section, and the concave portion 62 has a right triangle shape in cross section, to which the convex portion 61 is fitted.

Further, in FIG. 5A, FIG. 5B, and FIG. 5C, the convex portion 61 is formed on the lid member 50 side, and the concave portion 62 is formed on the outer peripheral core 5 side. The convex portion 61 is formed in any one of four sides (50b, 50c, 50d, and 50e) of the lid member 50, and the concave portion 62 is formed in a portion corresponding to the thus-formed convex portion 61, that is, a corresponding one of inner surfaces of four sides (5d1, 5b2, 5d2, and 5b1) of the outer peripheral core 5. In this case, it is preferred to provide at least one pair of convex and concave fitting structures 60. With regard to the one pair to be provided, it is preferred that the one pair is provided to be in the same horizontal plane and to be symmetrical with respect to a center point of the horizontal plane under a state of FIG. 1.

In FIG. 5A, the lid member 50 is inserted to the outer peripheral core 5 in the direction as indicated by the arrow A, with which the convex portion 61 on the lid member 50 side is fitted to the concave portion 62 on the outer peripheral core 5 side, and the lid member 50 is mounted to the outer peripheral core 5 while being positioned. Further, in FIG. 5B, the lid member 50 is inserted to the outer peripheral core 5 in the direction as indicated by the arrow A, with which the convex portion 61 on the lid member 50 side is fitted to the concave portion 62 on the outer peripheral core 5 side with a step surface 61a of the convex portion 61 being locked to an end surface 62a of the concave portion 62 on the opening side, and the lid member 50 is mounted to the outer peripheral core 5 while being positioned. Further, in FIG. 5C, the lid member 50 is inserted to the outer peripheral core 5 in the direction as indicated by the arrow A, with which the convex portion 61 on the lid member 50 side is fitted to the concave portion 62 on the outer peripheral core 5 side with the step surface 61a of the convex portion 61 being locked to a step surface 62b of the concave portion 62, and the lid member 50 is mounted to the outer peripheral core 5 while being positioned.

According to the magnetic element of the present invention, the lid member 50 is mounted to the opening 5a of the outer peripheral core 5, with which it is possible to reduce the gap between the coil 3 and the outer peripheral core 5 in the opening 5a, to thereby reduce the filling amount of the sealing resin. Thus, it is possible to achieve higher productivity and lower cost.

Through forming in the lid member 50 the air hole 55 through which the inside and the outside of the outer peripheral core 5 communicate with each other, it is possible to suppress formation of voids in the outer peripheral core 5, and provide a high-quality magnetic element.

Through providing in the lid member 50 the guide portions G1 and G2 configured to guide the coil terminals 3a and 3b to the outside, the coil terminals 3a and 3b protruding from the outer peripheral core 5 are stably connected to a connection portion of a substrate (not shown).

In the structure comprising the coil positioning portion M, the coil assembly 4 comprising the coil 3 and the inner core 2 can be fixed stably in a normal position by mounting the lid member 50 to the opening 5a of the outer peripheral core 5, and hence assembly can be easily performed.

Through providing between the lid member 50 and the outer peripheral core 5, the engagement part K configured to position the lid member 50 into a state of being mounted to the outer peripheral core 5, when the lid member 50 is mounted to the opening 5a of the outer peripheral core 5, the lid member 50 is mounted to the outer peripheral core 5 while being positioned. Accordingly, no positional alignment is required for the lid member 50, and an assembly operation can be simplified.

The engagement part K can be formed from the convex and concave fitting structures 60 provided at at least two positions. The engagement part K can be formed with a simple structure and in addition, enables stable engagement state (fitting state).

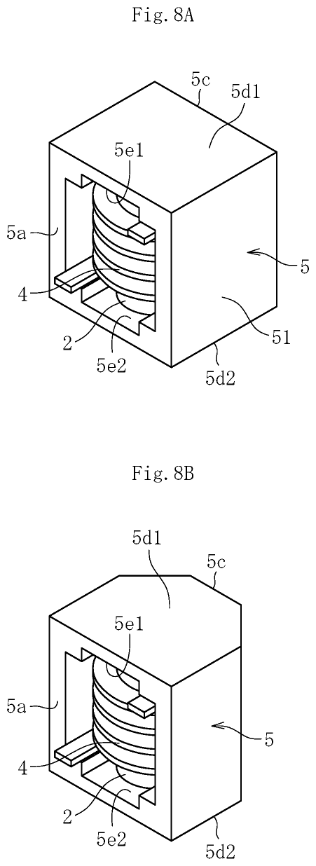

By the way, in the above-mentioned embodiment, the outer peripheral core 5 has the arc-shaped back wall 5c, but the back wall 5c may be a flat wall as illustrated in FIG. 8A, or a polygonal wall in cross section as illustrated in FIG. 8B.

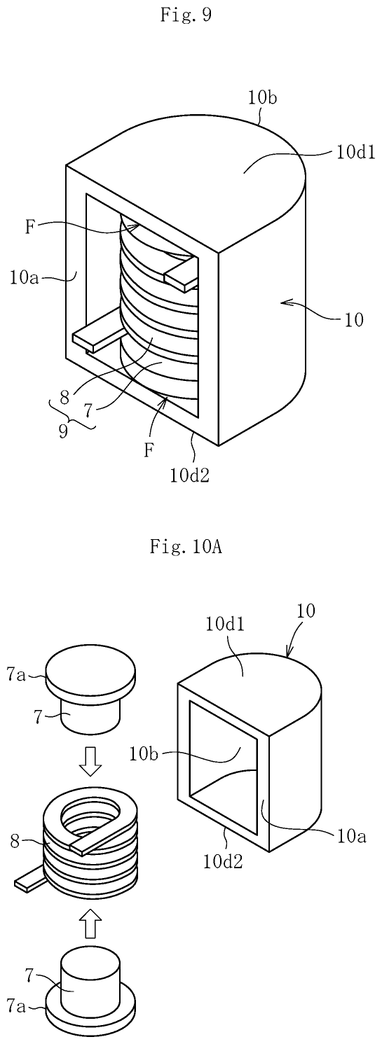

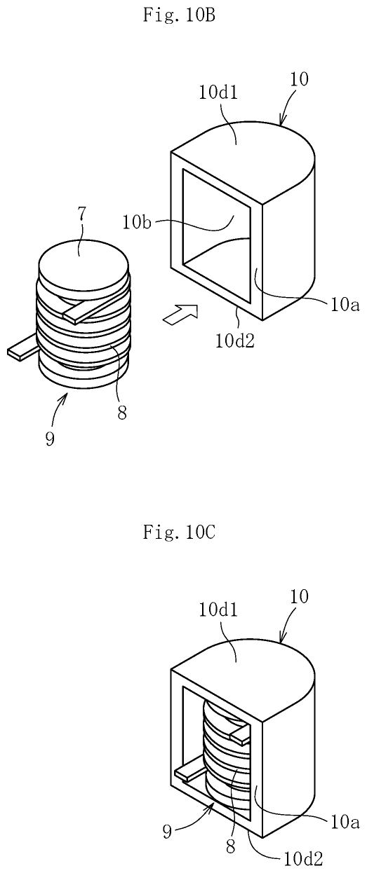

Further, in a magnetic element illustrated in FIG. 9 and FIG. 10A, one pair of cylindrical inner cores 7 and 7 are used, which have one pair of flange portions 7a provided at both ends in the axial direction. Thus, a coil 8 obtained by winding magnet wire is provided on an outer periphery of the one pair of inner cores 7 and 7 to form a coil assembly 9.

An outer peripheral core 10 does not have the grooves of FIG. 1, and an outer periphery of each flange portion 7a has a shape of being in close contact with an inner peripheral surface 10b of the outer peripheral core 10. By the outer periphery of each flange portion 7a being in close contact with the inner peripheral surface 10b, the coil assembly 9 is fixed into the outer peripheral core 10. Thus, an upper wall 10d1 and a lower wall 10d2 of the outer peripheral core 10, and the flange portions 7a and 7a of the inner cores 7 and 7 form the fixing parts F configured to fix the coil assembly 9 into the outer peripheral core 10. Here, as in the case of the outer peripheral core 5 of the magnetic element illustrated in FIG. 1, the outer peripheral core 10 may have grooves that allow outermost portions with the largest diameter of the drum-like inner core to be inserted thereto.

The two divided drum-like inner cores 7 are inserted in the axial direction of the coil 8 obtained in advance by winding magnet wire, along the directions as indicated by the arrows (FIG. 10A). The coil 8 may be obtained by directly winding magnet wire around the drum-like inner core 7. In this case, it is not required to divide the drum-like inner core 7 into two. The drum-like inner core 7 is inserted in the direction as indicated by the arrow so as to be in close contact with the inner peripheral surface 10b formed as an inner peripheral surface of the outer peripheral core 10 (FIG. 10B). That is, the coil assembly 9 is fixed into the outer peripheral core 10 by the outer peripheral surface of each flange portion 7a being in close contact with the inner peripheral surface 10b of the outer peripheral core 10.

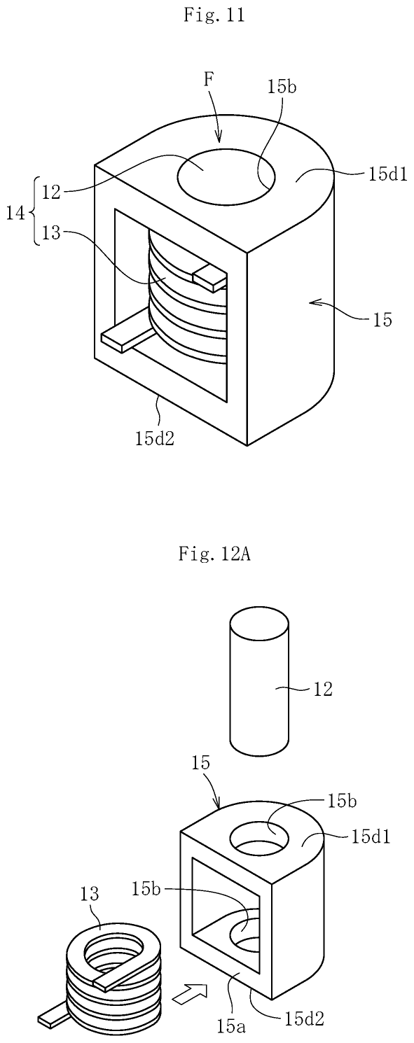

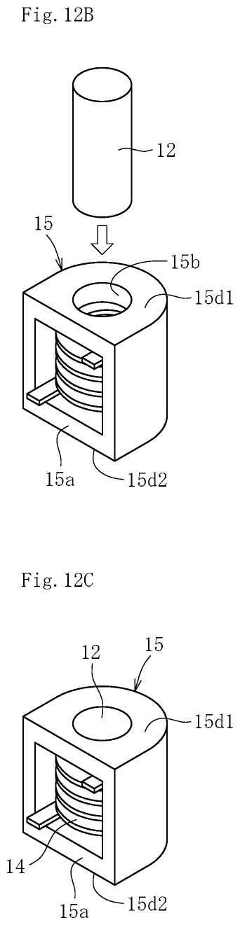

A magnetic element illustrated in FIG. 11 and FIG. 12 comprises a coil assembly 14 in which a coil 13 obtained by winding magnet wire is provided on an outer periphery of a cylindrical inner core 12. Further, an outer peripheral core 15 has through holes 15b and 15b which are formed in an upper wall 15d1 and a lower wall 15d2 of the outer peripheral core 15, and through which the inner core 12 can be inserted. It is possible to form the through hole 15b at two positions in the insertion direction of the inner core 12 such that one of the holes is the through hole 15b and another one is a non-through hole. The one non-through hole can serve as a retainer on one side in the axial direction.

The previously wound coil 13 is inserted through an opening 15a of the outer peripheral core 15 in the direction as indicated by the arrow (FIG. 12A), and the inner core 12 is inserted through a corresponding through hole 15b formed in an end surface of the outer peripheral core 15 in the direction as indicated by the arrow (FIG. 12B). Then, the coil assembly 14 comprising the coil 13 and the inner core 12 is fixed into the outer peripheral core 15 (FIG. 12C). Thus, in this case, the through holes 15b and end portions of the inner core 12 fitted into the through holes 15b form the fixing parts F configured to fix the coil assembly 14 into the outer peripheral core 15.

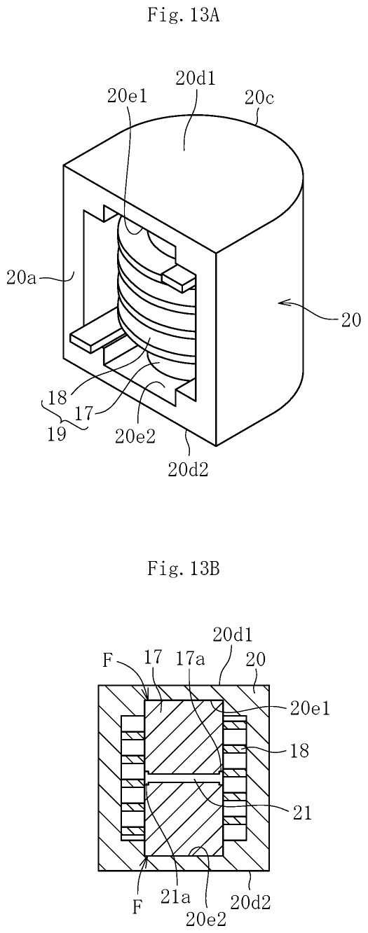

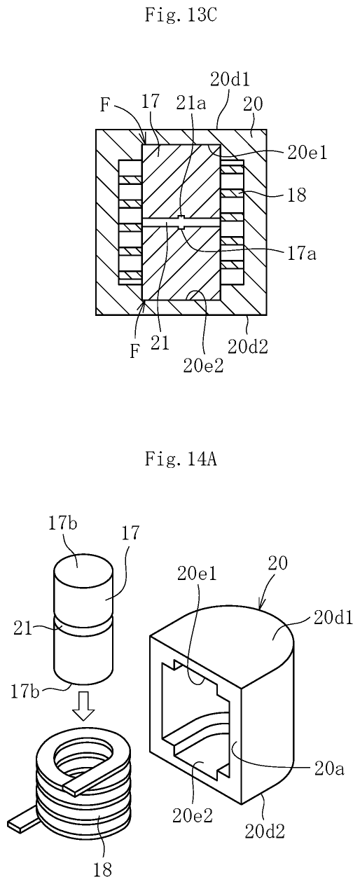

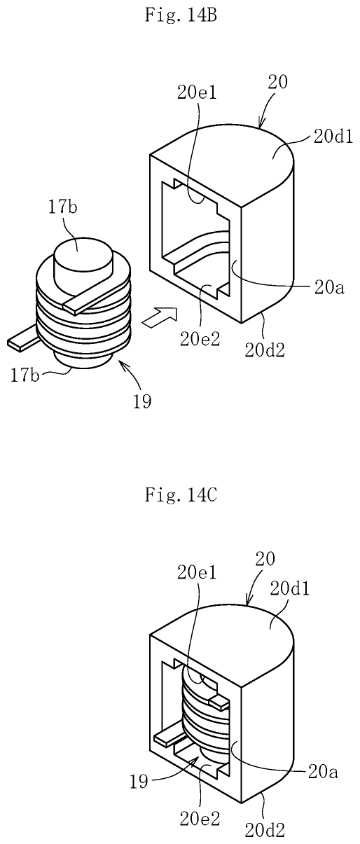

In a magnetic element illustrated in FIG. 13A to FIG. 13C and FIG. 14, an inner core 17 comprises a spacer 21 at an intermediate portion in the axial direction, and the spacer 21 comprises a fitting portion 21a with respect to the inner core 17. The fitting portion 21a may be formed at a circumferential portion of the inner core 17 as illustrated in FIG. 13B, or may be formed at a center portion in the axial direction of the inner core 17 as illustrated in FIG. 13C. In a portion of the inner core 17 to which the fitting portion 21a of the spacer 21 is to be fitted, a fitting portion 17a of the inner core 17 is formed. One of the fitting portion 21a and the fitting portion 17a has a convex shape while another one has a concave shape. Those two fitting portions can be integrated by being mutually fitted, without the use of an adhesive or other material.

In this case, an outer peripheral core 20 has an opening 20a that allows the coil assembly 19 to be inserted therein, and grooves 20e1 and 20e2 which serve to fix the coil assembly 19 into the outer peripheral core 20, and are formed both sides (up and down) of the opening. The cylindrical inner core 17 is inserted into a previously wound coil 18 in the direction as indicated by the arrow (FIG. 14A). Along the groove 20e1 of an upper wall 20d1 and the groove 20e2 of a lower wall 20d2 (each having the linear portion 6a on the opening side and the semicircular portion 6b on the back side as in the grooves 5e1 and 5e2), which are formed in an inner peripheral surface of the outer peripheral core 20, both end portions 17b of the cylindrical inner core 17 are inserted in the direction as indicated by the arrow. The grooves 20e1 and 20e2 are also used for positional alignment in the axial direction and the radial direction of the cylindrical inner core 17 except the insertion direction (FIG. 14B). That is, through the insertion of the assembly 19 along the grooves 20e1 and 20e2, the assembly 19 is fixed into the outer peripheral core 20 (FIG. 14C). Thus, in this case, the grooves 20e1 and 20e2 and the both end portions of the inner core 17 form the fixing parts F configured to fix the coil assembly 19 into the outer peripheral core 20.

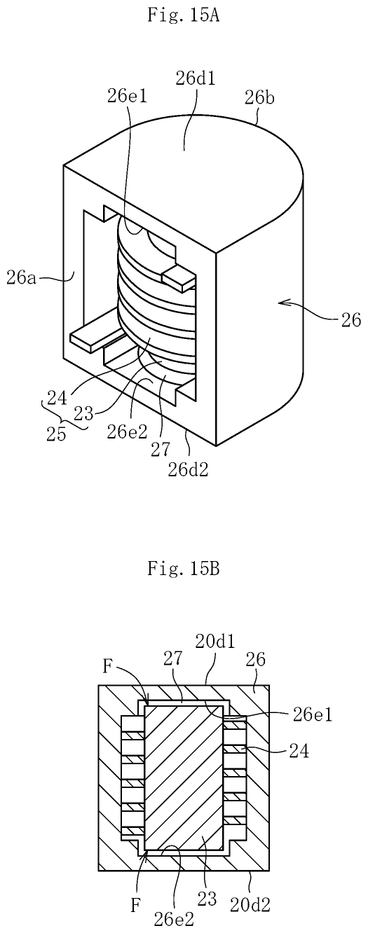

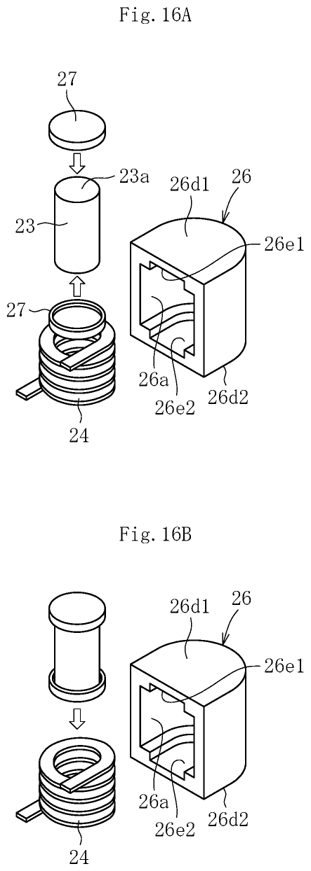

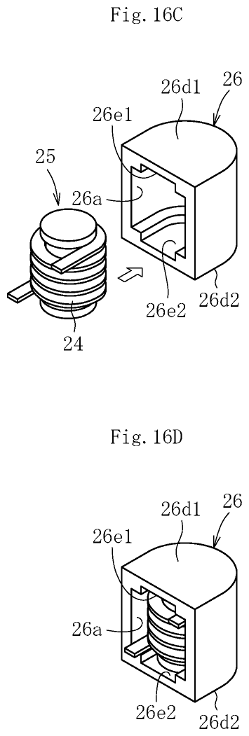

In a magnetic element illustrated in FIG. 15A, FIG. 15B, and FIG. 16, a coil assembly 25 is formed, which incorporates a coil 24 obtained by winding magnet wire is provided on an outer periphery of a cylindrical inner core 23 having one pair of spacers 27 formed as flange portions at both ends in the axial direction. The two spacers 27 are provided at both end surface portions in the axial direction of the cylindrical inner core 23 formed of a magnetic member. The spacers 27 have larger diameter than the diameter of the inner core 23, and are provided concentrically with the inner core 23. The spacers 27 are formed into a cylindrical flat-plate shape, and the end surfaces in the axial direction of the inner core 23 are each fitted into the cylindrical flat-plate shape. An outer peripheral core 26 has a groove 26e1 of an upper wall 26d1 and a groove 26e2 of a lower wall 26d2 (each having the linear portion 6a on the opening side and the semicircular portion 6b on the back side as in the grooves 5e1 and 5e2). By an outer periphery of the spacer 27 being inserted along the grooves 26e1 and 26e2 and brought into close contact therewith, the coil assembly 25 is fixed into the outer peripheral core 26.

The spacers 27 are fitted in advance to both end surface portions 23a in the axial direction of the inner core 23, and also the coil 24 is prepared. The coil 24 may be obtained by directly winding magnet wire around the inner core 23. Alternatively, the coil 24 obtained in advance by winding magnet wire may be inserted into the inner core 23 (FIG. 16A and FIG. 16B). The coil assembly 25 is fixed into the outer peripheral core 26 by the outer peripheral surface of each spacer 27 being brought into close contact with an inner peripheral surface 26c of the outer peripheral core 26 (FIG. 16C and FIG. 16D). Thus, in this case, the grooves 26e1 and 26e2 and the both end portions of the inner core 23 to which the spacers 27 are fitted, form the fixing parts F configured to fix the coil assembly 25 into the outer peripheral core 26.

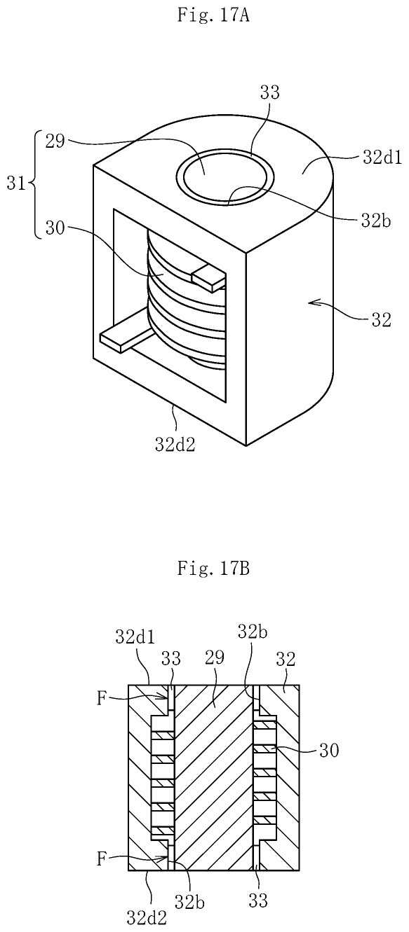

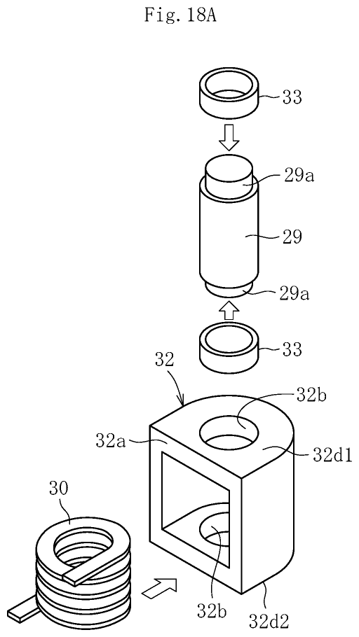

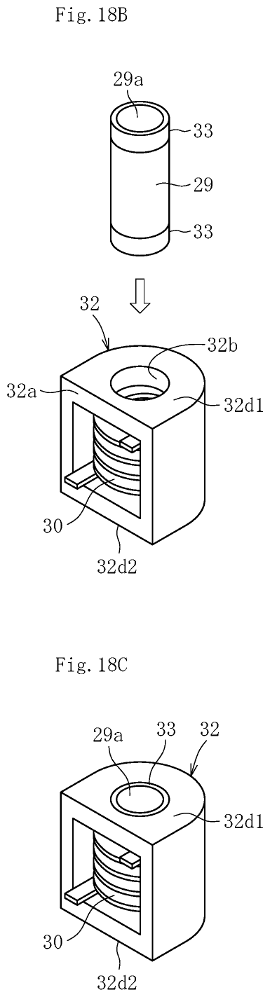

In a magnetic element illustrated in FIG. 17A and FIG. 17B, and FIG. 18A to FIG. 18C, an outer peripheral core 32 has through holes 32b and 32b that allow an inner core 29 to be inserted therein, and are formed in an upper wall 32d1 and a lower wall 32d2 of the outer peripheral core 32. Spacers 33 are fitted to circumferential portions 29a near end surfaces in the axial direction of the cylindrical inner core 29. The spacers 33 have a cylindrical shape to be fitted to the circumferential portions 29a being small-diameter portions in the axial direction provided near the end surfaces in the axial direction of the inner core 29.

A coil 30 obtained in advance by winding magnet wire is inserted through an opening 32a of the outer peripheral core 32 in the direction as indicated by the arrow (FIG. 18A), and the inner core 29 with the spacers is inserted through a corresponding through hole 32b formed in an end surface of the outer peripheral core 32 in the direction as indicated by the arrow (FIG. 18B). Then, a coil assembly 31 comprising the coil 30 and the inner core 29 is fixed into the outer peripheral core 32 (FIG. 18C). Thus, the through holes 32b and 32b and the end portions of the inner core 29 with the spacers 33, which are fitted into the through holes 32b and 32b, form the fixing parts F configured to fix the coil assembly 31 into the outer peripheral core 32.

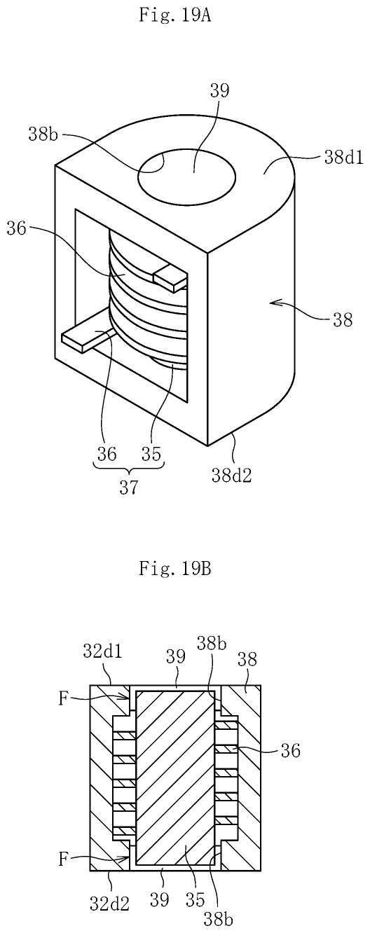

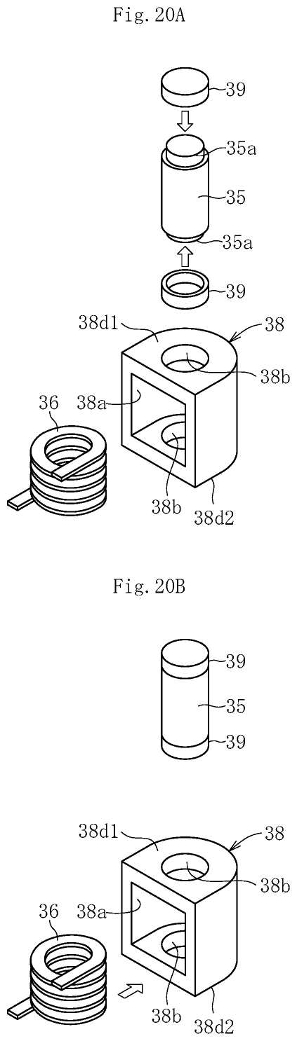

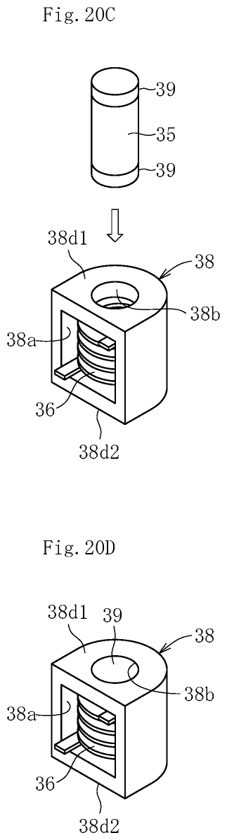

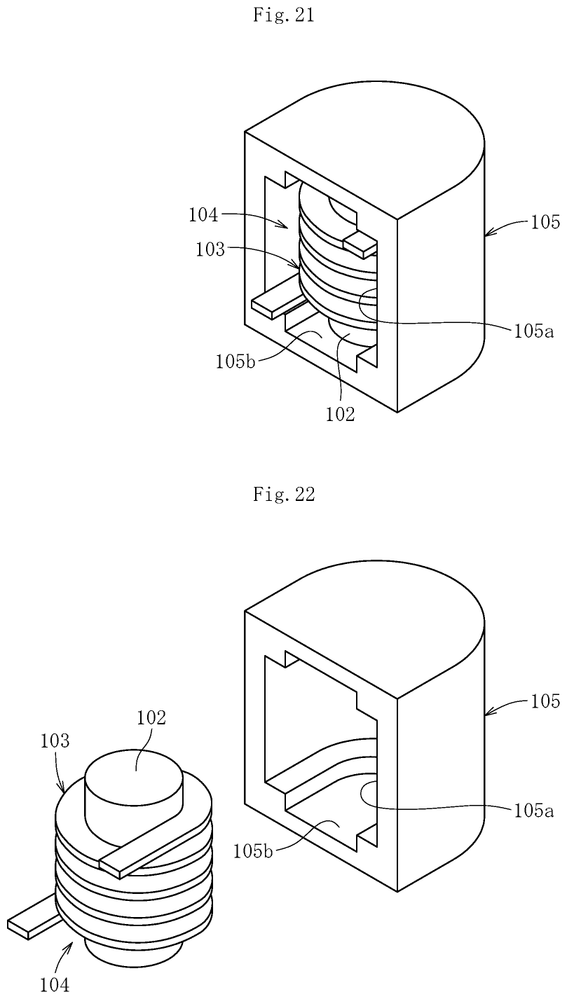

In a magnetic element illustrated in FIG. 19A and FIG. 19B, and FIG. 20A to FIG. 20D, through holes 38b that allow an inner core 35 to be inserted therein are formed in an upper wall 38d1 and a lower wall 38d2 of an outer peripheral core 38. Spacers 39 are provided at end surfaces and circumferential portions near both end surfaces in the axial direction of the cylindrical inner core 35. The spacers 39 have the same diameter as the diameter of the inner core 35, and are provided concentrically with the inner core 35. The spacers 39 are formed into a cylindrical flat-plate shape, and convex portions 35a of the end surfaces in the axial direction of the inner core 35 are fitted into the cylindrical flat-plate shape.

The spacers 39 are fitted from the both end surfaces of the inner core 35, and a coil 36 obtained in advance by winding magnet wire is inserted through an opening 38a of the outer peripheral core 38 in the direction as indicated by the arrow, and the inner core 35 is inserted in the direction as indicated by the arrow through the through holes 38b and 38b formed in the end surfaces of the outer peripheral core 38 (FIG. 20A to FIG. 20C). Then, a coil assembly 37 comprising the coil 36 and the inner core 35 is fixed into the outer peripheral core 38 (FIG. 20D). Thus, the through holes 38b and 38b and the end portions of the inner core 35 with the spacers 39, which are fitted into the through holes 38b and 38b, form the fixing parts F configured to fix the coil assembly 32 into the outer peripheral core 32.

In the magnetic elements illustrated in FIG. 8A to FIG. 20D, the lid member 50 illustrated in FIG. 1, for example, is omitted. However, the lid member 50 is mounted to the outer peripheral core of the respective magnetic elements. Thus, the above-mentioned magnetic elements achieve the same operation and effect as those of the magnetic element illustrated in FIG. 1 to FIG. 7.

The inner core and the outer peripheral core are preferably molded magnetic members inclusive of a compression-molded magnetic member and an injection-molded magnetic member, and more preferably are a compression-molded magnetic member and an injection-molded magnetic member, respectively.

A raw material of the compression molded magnetic body that can be used as the inner core may be a magnetic material, for example: a pure iron-based soft magnetic material, such as iron powder and iron nitride powder; an iron group alloy-based soft magnetic material, such as Fe—Si—Al alloy (sendust) powder, super sendust powder, Ni—Fe alloy (permalloy) powder, Co—Fe alloy powder, and Fe—Si—B-based alloy powder; a ferrite-based magnetic material; an amorphous-based magnetic material; and a microcrystalline material.

Examples of the ferrite-based magnetic material include: spinel ferrites each having a spinel-type crystal structure, such as manganese zinc ferrite, nickel zinc ferrite, copper zinc ferrite, and magnetite; hexagonal crystal ferrites, such as barium ferrite and strontium ferrite; and garnet ferrites, such as yttrium iron garnet. Among those ferrite-based magnetic materials, spinel ferrite is preferred, which is soft magnetic ferrite that has high magnetic permeability, and small eddy current loss in a high-frequency region. Further, examples of the amorphous magnetic material include an iron-alloy-based material, a cobalt-alloy-based material, a nickel-alloy-based material, and amorphous alloy materials as the mixtures thereof.

Examples of oxides that form insulating coating on the surfaces of particles of the soft magnetic metal powder material as a raw material include oxides of insulating metal such as Al₂O₃, Y₂O₃, MgO, and ZrO₂ or semimetal, glass, and mixtures thereof. As a method of forming the insulating coating, a powder coating method such as mechano-fusion, a wet thin-film formation method such as an electroless plating or sol-gel method, or a dry thin-film formation method such as sputtering can be used.

The compression-molded magnetic member can be produced by pressure-molding the above-mentioned raw material powder alone, in which the insulating coating is formed on the particle surface, or a powder prepared by blending a thermosetting resin such as an epoxy resin with the above-mentioned raw material powder, into a compact, and then firing the compact. A ratio of the raw material powder is preferably 96 to 100 mass % with a total amount of the raw material powder and the thermosetting resin being 100 mass %. When the ratio is less than 96 mass %, the blending ratio of the raw material powder is decreased, and there is a fear in that the magnetic flux density and the magnetic permeability are lowered.

The average particle size of the raw material powder is preferably 1 to 150 μm, more preferably 5 to 100 μm. With the average particle size of less than 1 μm, compressibility (measure of the ease of compression of a powder) during pressure molding is decreased, and a material strength after the firing is considerably reduced. With the average particle size of more than 150 μm, an iron loss in a high-frequency region is increased, and magnetic characteristics (frequency characteristics) are deteriorated.

The following method can be used for the compression molding. That is, the above-mentioned raw material powder is filled in a mold, followed by press-molding under a predetermined pressing force. The resultant compact is fired to obtain a fired member. When an amorphous alloy powder is used as the raw material, it is required to set the firing temperature to be lower than the temperature at which crystallization of the amorphous alloy starts. Further, when a powder blended with a thermosetting resin is used, it is required to set the firing temperature to fall within a temperature range in which the resin is cured.

The injection-molded magnetic member applicable to the outer peripheral core can be obtained by blending the raw material powder for the compression-molded magnetic member with a binder resin, and then injection-molding the resultant mixture. As the magnetic powder, an amorphous metal powder is preferred in terms of the ease of injection molding, the ease of maintaining a shape after the injection molding, and high magnetic characteristics of a composite magnetic member, for example. For the amorphous metal powder, the above-mentioned iron-alloy-based material, cobalt-alloy-based material, nickel-alloy-based material, and amorphous alloy materials as the mixtures thereof, for example, can be used. The insulating coating is formed on the surface of such an amorphous metal powder.

As the binder resin, a thermoplastic resin that can be subjected to injection molding may be used. Examples of the thermoplastic resin include: polyolefins, such as polyethylene and polypropylene; and polyvinyl alcohol, polyethylene oxide, polyphenylene sulfide (PPS), a liquid crystal polymer, polyether ether ketone (PEEK), polyimide, polyetherimide, polyacetal, polyethersulfone, polysulfone, polycarbonate, polyethylene terephthalate, polybutylene terephthalate, polyphenylene oxide, polyphthalamide, polyamide, and mixtures thereof. Among those, polyphenylenesulfide (PPS) is more preferred, which shows high flowability during the injection molding when blended with the amorphous metal powder, allows the surface of a molded member after the injection molding to be coated with a resin layer, and also has high heat resistance, for example.

A ratio of the raw material powder is preferably 80 to 95 mass % with a total amount of the raw material powder and the thermoplastic resin being 100 mass %. With the ratio of less than 80 mass %, magnetic characteristics cannot be obtained, and with the ratio of more than 95 mass %, there is a fear of insufficient injection-moldability.

For the injection molding, the following method can be used. That is, the above-mentioned raw material powder is injected and molded in a mold in which a movable mold and a fixed mold are butted, for example. Although conditions of the injection molding vary depending on the type of the thermoplastic resin, the conditions for polyphenylenesulfide (PPS), for example, are preferably such that: the resin temperature is 290 to 350° C.; and the mold temperature is 100 to 150° C.

The compression-molded magnetic member for the inner core and the injection-molded magnetic member for the outer peripheral core as preferred modes, are separately produced by the above-mentioned methods. Further, in the case of joining the compression-molded magnetic member and the injection-molded magnetic member, it is preferred to use a solvent-free epoxy-based adhesive that enables close contact therebetween.

As combinations of materials for the compression-molded magnetic member and the injection-molded magnetic member, it is preferred to adopt an amorphous material or pure iron powder for the compression-molded magnetic member, and adopt an amorphous metal powder and a thermoplastic resin for the injection-molded magnetic member. It is more preferred to adopt a Fe—Si—Cr-based amorphous material for the amorphous metal, and polyphenylenesulfide (PPS) for the thermoplastic resin.

When the resin sealing is performed, the sealing resin is preferably a thermosetting resin. Examples thereof include an epoxy resin, a phenol resin, and an acrylic resin that are excellent in heat resistance and corrosion resistance. As the epoxy resin, for example, a one-component or two-component epoxy resin having the same resin component as those exemplified in the resin binder may be used. In addition, as the curing agent for the epoxy resin, an amine-based curing agent, a polyamide-based curing agent, or an acid anhydride-based curing agent may be appropriately used as well as the latent epoxy curing agent. The curing temperature range and the curing time period thereof are preferably the same as those of the resin binder. As the phenol resin, for example, a novolac-type phenol resin or a resol-type phenol resin may be used as the resin component, and hexamethylenetetramine may be used as the curing agent. When the sealing resin is filled, the filling may be performed before or after the step of inserting of the coil into the peripheral core.

As the spacer applicable to the present invention, any spacer formed from a non-magnetic member can be used. For example, the above-mentioned thermoplastic resin as the binder resin, thermosetting resin as the sealing resin, ceramics, and non-magnetic metal, and foam of those materials can be used. The spacer can be formed into, for example, a cylindrical shape or a cylindrical flat-plate shape by injection molding or other method.

The magnetic element of the present invention can be given an inductor function, for example, by providing a coil obtained by winding magnet wire around the compression-molded magnetic member to forma coil assembly. The magnetic element is incorporated into a circuit of an electric/electronic apparatus. The magnetic wire can be enamel wire, and examples of its type include urethane wire (UEW), polyvinyl formal wire (PVF), polyester wire (PEW), polyesterimide wire (EIW), polyamideimide wire (AIW), polyimide wire (PIW), double coated wire formed from a combination thereof, self-welding wire, and litz wire. The polyamideimide wire (AIW), the polyimide wire (PIW), or other wire having high heat resistance is preferred. The magnet wire can be round or rectangular in cross section. In particular, a coil assembly having high coil density can be obtained by winding rectangular wire in contact with the periphery of the compression-molded magnetic member with some overlap at a short side of the rectangular wire in cross section. The conductor for the magnetic wire may be any metal of high conductivity, and examples thereof include copper, aluminum, gold, and silver.

The embodiment of the present invention has been described above, but the present invention is not limited to the above-mentioned embodiment and can be modified in various ways. In the above-mentioned embodiment, the convex and concave fitting structures 60 that form the engagement parts K each have the convex portion 61 on the lid member 50 side, and the concave portion 62 on the outer peripheral core 5 side. However, it is possible to conversely provide the concave portion 62 on the lid member 50 side and the convex portion 61 on the outer peripheral core 5 side. Further, the convex and concave fitting portions 60 may be provided at different positions in the vertical direction. Further, three or more convex and concave fitting structures 60 may be provided.

The convex portion 61 and the concave portion 62 are not limited to the shapes illustrated in FIG. 5A, FIG. 5B, and FIG. 5C, and can have various shapes such as an isosceles triangular shape, a trapezoidal shape, a semicircular shape, and a semi-elliptic shape in cross section. Further, in the illustrated example, the air hole is a rectangular hole but may be a circular hole, an elliptic hole, or a polygonal hole. Furthermore, the number of air holes is not limited to one. It is possible to form a through-passage into which a corresponding coil terminal is to be fitted, as the guide portions G1 and G2 for the coil terminals.

### INDUSTRIAL APPLICABILITY

The magnetic element of the present invention can be used as magnetic elements such as an inductor, a transformer, an antenna, a choke coil, and a filter for use in power supply circuits, filter circuits, switching circuits, or other circuits of vehicles inclusive of motorcycles, industrial apparatus, and medical apparatus. Further, the magnetic element can be used as a surface-mount component. In particular, when a high-efficiency DC/DC converter, charger, and inverter are to be applied to solar power generation or to be mounted to vehicles, such a device is required to achieve small size and low height. Accordingly, the inductor of the present invention can be suitably used therefor.

### REFERENCE SIGNS LIST

2, 7, 12, 17, 23, 29, 35 inner core
3, 8, 13, 18, 24, 30, 36 coil
3a coil terminal
3b coil terminal
4, 9, 14, 19, 25, 31, 37 coil assembly
5, 10, 15, 20, 26, 32, 38 outer peripheral core
5a, 10a, 15a, 20a, 32a, 38a opening
50 lid member
51 concave portion
55 air hole
60 convex and concave fitting structure
G1, G2 coil terminal guide portion
K engagement part
M coil positioning portion

1. A magnetic element comprising:
a coil assembly in which a coil is provided on an outer periphery of an inner core;
an outer peripheral core provided to cover an outer periphery of the coil assembly,
the outer peripheral core having:
an opening that allows the coil assembly to be inserted therein; and
a fixing part configured to fix the coil assembly into the outer peripheral core, the coil being sealed by a sealing resin,
wherein a lid member is mounted to an opening of the outer peripheral core, the lid member being configured to reduce a gap between the coil and the outer peripheral core in the opening so as to reduce a filling amount of the sealing resin.

2. The magnetic element according to claim 1, wherein the lid member has an air hole through which an inside and an outside of the outer peripheral core communicate with each other.

3. The magnetic element according to claim 1, wherein the lid member comprises a guide portion through which a coil terminal is guided to an outside.

4. The magnetic element according to claim 1, wherein the lid member comprises a coil positioning portion configured to guide the coil to position the coil and the inner core.

5. The magnetic element according to claim 1, wherein an engagement part is provided between the lid member and the outer peripheral core, the engagement part being configured to position the lid member into a state of being mounted to the outer peripheral core.

6. The magnetic element according to claim 5, wherein the engagement part comprises a convex and concave fitting structure provided at at least two positions.

7. The magnetic element according to claim 2, wherein the lid member comprises a guide portion through which a coil terminal is guided to an outside.

8. The magnetic element according to claim 2, wherein the lid member comprises a coil positioning portion configured to guide the coil to position the coil and the inner core.

9. The magnetic element according to claim 3, wherein the lid member comprises a coil positioning portion configured to guide the coil to position the coil and the inner core.

10. The magnetic element according to claim 7, wherein the lid member comprises a coil positioning portion configured to guide the coil to position the coil and the inner core.

11. The magnetic element according to claim 2, wherein an engagement part is provided between the lid member and the outer peripheral core, the engagement part being configured to position the lid member into a state of being mounted to the outer peripheral core.

12. The magnetic element according to claim 3, wherein an engagement part is provided between the lid member and the outer peripheral core, the engagement part being configured to position the lid member into a state of being mounted to the outer peripheral core.

13. The magnetic element according to claim 4, wherein an engagement part is provided between the lid member and the outer peripheral core, the engagement part being configured to position the lid member into a state of being mounted to the outer peripheral core.

14. The magnetic element according to claim 7, wherein an engagement part is provided between the lid member and the outer peripheral core, the engagement part being configured to position the lid member into a state of being mounted to the outer peripheral core.

15. The magnetic element according to claim 8, wherein an engagement part is provided between the lid member and the outer peripheral core, the engagement part being configured to position the lid member into a state of being mounted to the outer peripheral core.

16. The magnetic element according to claim 9, wherein an engagement part is provided between the lid member and the outer peripheral core, the engagement part being configured to position the lid member into a state of being mounted to the outer peripheral core.

17. The magnetic element according to claim 10, wherein an engagement part is provided between the lid member and the outer peripheral core, the engagement part being configured to position the lid member into a state of being mounted to the outer peripheral core.

18. The magnetic element according to claim 11, wherein the engagement part comprises a convex and concave fitting structure provided at at least two positions.

19. The magnetic element according to claim 12, wherein the engagement part comprises a convex and concave fitting structure provided at at least two positions.

20. The magnetic element according to claim 13, wherein the engagement part comprises a convex and concave fitting structure provided at at least two positions.
